(19) United States
(12) Patent Application Publication
(10) Pub. No.: US 2007/0172569 A1
(43) Pub. Date: Jul. 26, 2007

(54) Stable cola flavor emulsion and method

(76) Inventors: Pei K. Chang, Cortlandt Manor, NY (US); Kathleen K. Latimer, Croton-on-Hudson, NY (US); Christine J. Sisler, Shrub Oak, NY (US)

Correspondence Address: PEPSICO, INC.;c/o GOODWIN PROCTER LLP, 599 LEXINGTON AVE, NEW YORK, NY, 10022, US

(21) Appl. No.: 11/338,972

(22) Filed: Jan. 25, 2006

(51) Int. Cl. A23L 2/00

(52) U.S. Cl. 426/590

(57) ABSTRACT

A cola flavor emulsion, resulting beverage and method of making a cola flavor emulsion and beverage are provided. The cola flavor emulsion is resistant to exhibiting adverse flavor effects as a result of exposure to elevated temperature. The cola flavor emulsion has a pH in the range of from about 0.65 to about 0.9.

### FIELD OF THE INVENTION

The present invention relates to cola flavor emulsions and beverages made therefrom. More particularly, the present invention relates to cola flavor emulsions that are resistant to heat degradation.

### BACKGROUND OF THE INVENTION

Cola beverages are typically made by combining a cola flavor syrup with carbonated water. The cola syrup is composed of an acidified cola flavor emulsion that is added to other components including acid, water, sweetener and optionally caffeine as is known in the art. The cola flavor emulsion typically is made and distributed as a separate component of the cola syrup and is later combined with the other syrup components. Thus, the flavor emulsion is subjected to storage and shipping which can result in exposure to elevated temperatures. Exposure to elevated temperatures can cause a degradation or adverse effect upon the flavor of the cola emulsion.

Consequently, a need exists for an improved cola flavor emulsion that has improved resistance to adverse effects on flavor or flavor degradation as a result of exposure to elevated temperature.

### SUMMARY OF THE INVENTION

In accordance with the present invention, a cola flavor emulsion is provided that is resistant to exhibiting adverse flavor effects as a result of exposure to elevated temperature. The cola flavor emulsion can also exhibit extended shelf life with more consistent quality throughout the shelf life.

A method of making a cola flavor emulsion and cola beverage is also provided.

Surprisingly, it has been discovered that by controlling the amount of acid in the cola flavor emulsion for pH adjustment, improved resistance to flavor degradation and adverse flavor effects is provided. In accordance with one aspect of the invention, a cola flavor emulsion that is resistant to flavor degradation from exposure to elevated temperature is provided. The cola flavor emulsion comprises from about 1.2% to about 2.6% by weight cola flavor, caramel color, water and from about 8% to about 11% by weight phosphoric acid. The cola flavor emulsion in accordance with the invention has a pH of from about 0.65 to about 0.9. More particularly, the cola flavor emulsion of the invention contains from about 1.5% to about 2.5% cola flavor by weight and preferably about 2.5% cola flavor by weight.

The cola flavor emulsion of the invention may include further ingredients as desired and may include, for example, vanilla extract.

More particularly, the pH of the cola flavor emulsion can be from about 0.7 to about 0.85. The phosphoric acid may be present in an amount of from about 8.5% to about 10.5% by weight.

In accordance with another aspect of the invention, a cola flavor emulsion is provided that is resistant to flavor degradation as a result of exposure to elevated temperature. The cola flavor emulsion in accordance with the present invention comprises from about 1.2% to about 2.6% by weight cola flavor and more particularly from about 1.5% to about 2.5% by weight cola flavor, caramel color, water and a food grade acid present in an effective amount to provide a pH of the cola flavor emulsion of from about 0.65 to about 0.9 and more preferably from about 0.7 to about 0.85.

The food grade acid for use in accordance with the invention can be selected from phosphoric acid, citric acid and combinations thereof. Typically, phosphoric acid that is utilized in the invention will be 80% by weight phosphoric acid. The amounts of phosphoric acid as stated herein are based on the absolute amount of phosphoric acid present. Thus, if the composition contains 10% by weight of 80% phosphoric acid, the absolute amount of phosphoric acid present in the composition is 10%×0.8=8% phosphoric acid.

More particularly, in this embodiment, the pH of the cola flavor emulsion is from about 0.7 to about 0.85.

In accordance with another aspect of the invention, a method of making a cola flavor beverage is provided. The method includes combining: (1) a cola flavor emulsion comprising from about 1.2% to about 2.6% and preferably from about 1.5% to about 2.5% by weight of the cola flavor, caramel color, water and a food grade acid present in an amount to provide a pH of the cola flavor emulsion of from about 0.65 to about 0.9 and preferably from about 0.7 to about 0.85; the method can further include combining the flavor emulsion with (2) a sweetener, water and a food grade acid to form a syrup composition.

The method may further include combining the syrup composition with water to form the cola beverage. Typically, carbonated water will be used.

In accordance with one aspect of the method, the food grade acid that is used is selected from phosphoric acid, citric acid and combinations thereof, with phosphoric acid being preferred.

The cola flavor emulsion used in accordance with the method can be as described previously with respect to the cola flavor emulsion.

In accordance with another aspect of the invention, a method of making a cola flavor emulsion is provided. The method includes combining cola flavor, water and caramel color to form a mixture and adjusting the pH of the mixture with a food grade acid to a pH in the range of from about 0.65 to about 0.90. Preferably, the food grade acid is phosphoric acid and typically is present in an amount of from about 8% to about 11% by weight of the total cola flavor emulsion.

### DETAILED DESCRIPTION OF THE INVENTION

In accordance with the present invention, a cola flavor emulsion is provided that is resistant to exhibiting adverse flavor effects as a result of exposure to elevated temperature. “Elevated temperature” as used herein is a temperature above 70° F. and may be, for example, 80° F., 90° F. or more.

A cola flavor emulsion in accordance with the invention is resistant to flavor degradation from exposure to elevated temperature. The cola flavor emulsion comprises from about 1.2% to about 2.6% by weight cola flavor, caramel color, water and from about 8% to about 11% by weight phosphoric acid. The cola flavor emulsion in accordance with the invention has a pH of from about 0.65 to about 0.9. More particularly, the cola flavor emulsion of the invention contains from about 1.5% to about 2.5% cola flavor by weight and preferably about 2.5% cola flavor by weight.

In accordance with the invention, any suitable cola flavor can be utilized. Cola flavors are well known to those in the art.

Typically, the caramel color will be present in an amount of from about 60% to about 80% by weight of the composition with about 70.8% being preferred.

The water that is used in the cola flavor emulsion of the present invention should be sufficiently free of minerals and other additives or impurities so that the taste of the resulting beverage is not adversely affected. Suitable water for use in accordance with the invention includes water having a hardness of less than about 50 ppm measured as calcium carbonate.

In accordance with the invention, a food grade acid is utilized in the cola flavor beverage emulsion to provide a pH in the range of from about 0.65 to about 0.9 and preferably from about 0.7 to about 0.85. Suitable acids include food acids selected from phosphoric acid, citric acid and combinations thereof. Phosphoric acid is a preferred acid for use in accordance with the invention.

In accordance with another aspect of the invention, a method of making a cola flavor emulsion is provided. The method includes combining cola flavor, water and caramel color to form a mixture and adjusting the pH of the mixture with a food grade acid to a pH in the range of from about 0.65 to about 0.9. Preferably, the food grade acid is phosphoric acid and typically is present in an amount of from about 8% to about 11% by weight of the total cola flavor emulsion.

The cola flavor composition can be formed into an emulsion by homogenizing, for example. Homogenization causes the water insoluble flavors to be dispersed into very small particles with diameters typically ranging from as high as about 1.2 microns to below about 0.5 micron. Preferably, for carbonated soft drink applications, the average diameter should be less than about 1 micron to achieve a stable emulsion.

In accordance with another aspect of the invention, a method of making a cola flavor beverage is provided. The method includes combining a cola flavor emulsion comprising from about 1.2% to about 2.6% by weight cola flavor, caramel color, water and a food grade acid present in an amount to provide a pH of the cola flavor emulsion of from about 0.65 to about 0.9 and preferably from about 0.7 to about 0.85, with a sweetener, water and a food grade acid to form a syrup composition. The syrup composition may then be combined with water, typically carbonated water, to form the cola beverage.

Cola flavor emulsions in accordance with the invention are more resistant to flavor degradation caused by storage at elevated temperature than known prior cola flavor emulsions. Cola flavor emulsions in accordance with the present invention can also exhibit extended shelf-life compared to prior cola flavor emulsions that are used to make cola flavor beverages.

### EXAMPLES

A control flavor emulsion and two flavor emulsions in accordance with the invention were made having compositions on a percent by weight basis as set forth in the following table.

TABLE I

| | Flavor Emulsions | | |
|---|---|---|---|
| | | Inventive | Inventive |
| Component | Control Emulsion | Emulsion #1 | Emulsion #2 |
| Caramel Color | 70.80 | 70.80 | 70.80 |
| Phosphoric Acid, 80% | 16.74 (13.4) | 13.6 (10.9) | 10.88 (8.7) |
| (Total Phosphoric Acid | | | |
| %) | | | |
| Cola Flavor | 2.49 | 2.49 | 2.49 |
| Vanilla Extract | 0.14 | 0.14 | 0.14 |
| Water | 9.83 | 12.97 | 15.69 |
| TOTAL | 100 | 100 | 100 |
| pH | 0.44 | 0.68 | 0.84 |

Samples of each of the emulsions were stored at 70° F. and 90° F. for 6 weeks prior to making into beverages. All above emulsions became components of a syrup composition as shown below:

| | | |
|---|---|---|
| Aspartame sweetener | 3.0 | gms |
| Potassium Benzoate | 1.4 | gms |
| Phosphoric Acid (80%) | 0.85 | gms* |
| Citric Acid | 0.29 | gms |
| Caffeine | 0.6 | gms |
| Flavor Emulsion | 8.9 | ml |
| Add water to a total volume of | 1000 | ml |

*Additional phosphoric acid needs to be added to the syrup for adjustment
for the inventive emulsions 1 and 2 since lesser amounts of acids were
used in the preparation of these emulsions. For example, when the acid
level is less than the original 16.74% in these formulas, extra acid needs
to be added. The extra amount of 80% phosphoric acid added to one liter
of syrup is shown below:

| | |
|---|---|
| Emulsion 1 | 0.355 gms |
| Emulsion 2 | 0.662 gms |

All above formulas were based on 1 liter of syrup. The final beverage can be prepared from these syrups at a 1 plus 5 throw to produce beverages (1 part of beverage plus 5 parts of carbonated water with a CO2 volume of 4.7).

The beverages were stored at 70° F. and 90° F. for 14 weeks.

Table II shows the sensory evaluation results.

TABLE II

| Formula | Control Emulsion | Control Emulsion | Inventive Emulsion 1 | Inventive Emulsion 2 |
|---|---|---|---|---|
| Emulsion Storage | 70° F. | 90° F. | 90° F. | 90° F. |
| Temp | | | | |
| Taste | Control typical | Dissimilar in taste to | Similar in taste to | Similar in taste to |
| | | Control at 70° F. with | Control at 70° F. | Control at 70° F. |
| | | some off-note | | |

The above findings show that beverages made with the inventive emulsions stored at 90° F. with low acid are beneficial in maintaining the same taste characteristics of a non-modified control stored at 70° F. In addition, the non-modified control stored at 90° F. exhibited a non-desirable taste when compared to storage at 70° F.

This example further demonstrates the amount of acid reduction is critical in maintaining a similar taste to the control.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A cola flavor emulsion that is resistant to heat degradation comprising:
from about 1.2% to about 2.6% by weight cola flavor, caramel color, water and from about 8% to about 11% by weight phosphoric acid, said cola flavor emulsion having a pH of from about 0.65 to about 0.9.

2. The cola flavor emulsion of claim 1 comprising from about 1.5% to about 2.5% cola flavor by weight.

3. The cola flavor emulsion of claim 1 further comprising vanilla extract.

4. The cola flavor emulsion of claim 1 wherein the pH of the cola flavor emulsion is from about 0.7 to about 0.85.

5. The cola flavor emulsion of claim 1 comprising from about 8.5% to about 10.5% phosphoric acid by weight.

6. The cola flavor emulsion of claim 2 wherein the cola flavor emulsion has a pH of from about 0.7 to about 0.85.

7. The cola flavor emulsion of claim 6 comprising from about 8.5% to about 10.5% phosphoric acid by weight.

8. A cola flavor emulsion that is resistant to heat degradation comprising from about 1.2% to about 2.6% by weight cola flavor, caramel color, water and a food grade acid present in an amount to provide a pH of the cola flavor emulsion of from about 0.65 to about 0.9.

9. The cola flavor emulsion of claim 8 wherein the food grade acid is selected from the group consisting of phosphoric acid, citric acid and combinations thereof.

10. The cola flavor emulsion of claim 8 comprising from about 1.5% to about 2.5% cola flavor by weight.

11. The cola flavor emulsion of claim 8 wherein the pH of the cola flavor emulsion is from about 0.7 to about 0.85.

12. The cola flavor emulsion of claim 1 further comprising vanilla extract.

13. The cola flavor emulsion of claim 9 wherein the pH of the cola flavor emulsion is from about 0.7 to about 0.85.

14. A method of making a cola flavor beverage comprising:
combining a cola flavor emulsion comprising from about 1.2% to about 2.6% by weight cola flavor, caramel color, water and a food grade acid present in an amount to provide a pH of the cola flavor emulsion of from about 0.65 to about 0.9 with a sweetener, water and a food grade acid to form a syrup composition.

15. The method of claim 14 further comprising combining the syrup composition with water to form the cola beverage.

16. The method of claim 15 wherein the water is carbonated water.

17. The method of claim 14 wherein the food grade acid of the cola flavor emulsion is selected from the group consisting of phosphoric acid, citric acid and combinations thereof.

18. The method of claim 14 wherein the cola flavor emulsion comprises phosphoric acid.

19. The method of claim 14 wherein the pH of the cola flavor emulsion is from about 0.7 to about 0.85.

20. The method of claim 14 wherein the cola flavor emulsion comprises from about 1.5% to about 2.5% cola flavor by weight.

21. A method of making a cola flavor emulsion comprising:
combining cola flavor, water and caramel color to form a mixture;
adjusting the pH of the mixture with a food grade acid to a pH in the range of from about 0.65 to about 0.90.

22. The method of claim 21 wherein the food grade acid is phosphoric acid present in an amount of from about 8% to about 11% by weight of the total cola flavor emulsion.
